(19) United States
(12) Patent Application Publication
(10) Pub. No.: US 2014/0061973 A1
(43) Pub. Date: Mar. 6, 2014

(54) INJECTION MOLDING DEVICE COMPRISING A SLIDE

(71) Applicant: Valeo Vision, Bobigny Cedex (FR)

(72) Inventor: Patrice Bourgaut, La Fleche (FR)

(21) Appl. No.: 13/974,381

(22) Filed: Aug. 23, 2013

(30) Foreign Application Priority Data
Aug. 28, 2012 (FR) 1258029

(51) Int. Cl. B29C 45/40; B29C 45/00

(52) U.S. Cl. CPC B29C 45/4005; B29C 45/00
USPC 264/328.1; 425/556

(57) ABSTRACT

A device and method for molding a plastic component, comprising a slide movable in a translational movement between a position in which the slide is open and a position in which the slide is closed, the slide comprising a cold runner opening into the molding cavity and the device comprising an ejection member for ejecting plastic sprue formed in the cold runner. The ejection member comprises at least two parts, the first part being borne by the mobile part and the second part being borne by the slide, the slide being movable between a position in which the two parts of the ejection member are offset and a position in which the two parts of the ejection member are more or less aligned so that they can collaborate with one another. The molding cavity comprises a region intended to form a rib or a tab of the plastic component, the cold runner opening into this region.

### CROSS-REFERENCE TO RELATED APPLICATIONS

This application claims priority to French Application No. 1258029 filed Aug. 28, 2012, which is incorporated herein by reference and made a part hereof.

### BACKGROUND OF THE INVENTION

1. Field of the Invention

The present invention relates to the field of the injection-molding of a plastic component, notably a shade for a motor vehicle lighting device.

2. Description of the Related Art

Devices for injection-molding thin plastic components, for example motor vehicle headlamp shades, are known from the prior art. These molding devices usually comprise two parts, respectively a fixed part and a mobile part, which can be moved relative to one another between a position in which the molding device is open and a position in which the device is closed, a slide movable in a translational movement between a position in which the slide is open and a position in which the slide is closed, the two parts and the slide forming a cavity in which to mold the plastic component. These molding devices additionally comprise one or more injection nozzles opening into the molding cavity. The nozzles are positioned, in the molding device, in such a way as to optimize the flow of plastic in the molding cavity and thus obtain a relatively low reject rate for the molded components.

However, for aesthetic reasons, motor vehicle headlamp shades cannot have an injection mark on their visible faces. It is therefore desirable to inject the plastic in regions of the shade which will not be visible when the headlamp is mounted on the motor vehicle.

This constraint sometimes makes it difficult to optimize the position of the points at which plastic is injected into the molding cavity, particularly when the molding device comprises a slide.

The problem is that access to an optimum point of injection into the cavity sometimes involves resorting to a cold runner.

A cold runner means a runner formed in a molding device and in which, after plastic has been injected, sprue remains connected to the molded element as long as this element is still in the mold. This sprue is intended to be detached from the molded component as this component is extracted from the mold. The cold runner joins together the injection orifice of a nozzle that injects the plastic and the molding cavity.

However, extracting the sprue from the molding device requires at least one ejection member which is usually borne by the mobile part of the molding device.

Given the relative movement between the mobile part of the molding device and the slide, when this slide is opened, this slide is not fitted with an ejection member. There is therefore nothing to encourage the siting of a cold runner in the slide, because there is no ejection member in this slide.

Thanks to the cold runner, the injection orifice of the injection nozzle can be delocalized from the orifice of the cold runner that opens into the cavity, making it easier to position the nozzle in the molding device. In addition, the cold runner allows access to the optimum point at which material should be injected into the cavity.

### SUMMARY OF THE INVENTION

It is an object of the invention to propose a device for molding a thin plastic component comprising a slide and offering greater flexibility regarding the positioning of the injection nozzles.

To that end, one subject of the invention is a device for molding a plastic component, this device comprising two parts, respectively a fixed part and a mobile part, which can be moved relative to one another between a position in which the molding device is open and a position in which the device is closed, a slide movable in a translational movement between a position in which the slide is open and a position in which the slide is closed, the two parts of the device and the slide forming a cavity in which to mold the plastic component.

According to the invention, the slide comprises a cold runner opening into the molding cavity, and the device comprises an ejection member for ejecting plastic sprue formed in the cold runner, this ejection member being movable in an ejection direction and comprising at least a first part and a second part, the first part of the ejection member being borne by the mobile part of the device and the second part of the ejection member being borne by the slide, the slide being movable, substantially perpendicularly to the direction in which the ejection member moves, between a position in which the two parts of the ejection member are offset from one another, which corresponds to the closed position of the slide, and a position in which the two parts of the ejection member are more or less aligned with one another so that they can collaborate with one another, which corresponds to the open position of the slide, and the molding cavity comprises a zone intended to form a rib or a tab of the plastic component, the cold runner opening into this region.

Thanks to the slide or slider, it is possible to mold an object that has at least one backdraft surface.

The ejection member of the device made in two parts, namely a first part borne by the mobile part and a second part borne by the slide, allows the slide dynamics to be taken into consideration. Thus, when the slide is in the closed position, the two parts of the ejection member are offset from one another and cannot collaborate with one another. It is therefore not possible for the ejection member to be moved from its rest position to its ejection position.

When the molding device and the slide are in the open position, the two parts of the ejection member can collaborate with one another. It is then possible to eject the sprue which has solidified in the cold runner.

Because the cold runner is formed in the slide, it is possible to position a plastic-injection point in a part of the molding cavity that corresponds to a part of the component being molded that has no aesthetic function and is not accessible to the mobile part of the molding device.

It is thus possible to optimize the positioning of the points at which plastic is injected into the molding device so that the plastic component obtained after injection molding notably has no injection marks on its parts that have an aesthetic function, in this instance which are visible, when the component is mounted on the motor vehicle headlamp.

In addition, when the slide moves from its closed position to its open position, because the plastic component remains secured to the mobile part of the device, the sprue is detached from the plastic component by the breakage of material. There is no need to provide an additional step in order to bring about this breakage.

The molding device may also comprise one or more of the following features, considered alone or in combination.

The cold runner comprises a plastic-injection part of substantially conical shape opening into the molding cavity and substantially converging toward this molding cavity. This conical shape makes it possible continuously to reduce the bore section for the plastic from the injection part as far as the point of injection into the mold cavity.

The injection part of substantially conical shape is defined by a generatrix, the generatrix forming, with the direction of travel of the ejection member, an angle smaller than 45°, preferably less than or equal to 30°. The bulk of the injection part and therefore the bulk of the slide in the direction parallel to its direction of travel with respect to the mobile part of the molding device is thus reduced. Further, this angle allows for ease of ejection of the plastic sprue from the cold runner.

The cold runner comprises a homogenizing cavity connected on the one hand to a plastic-injection orifice of an injection nozzle and on the other hand to the injection part of substantially conical shape. This cavity allows the stream of plastic injected under pressure to be homogenized before it is injected into the molding cavity.

The cold runner comprises an extension extending between the homogenizing cavity and one end of the second part of the ejection member. Thanks to the extension of the cold runner, the plastic sprue that forms in the molding cavity during injection molding is more readily ejected from the slide.

The second part of the ejection member is slidably mounted in a chamber formed in the slide, the second part of the ejection member being movable between a position of rest toward which it is elastically returned, and a sprue-ejection position. Thus the volume of the cold runner and, more particularly, of the extension, is reduced. The amount of sprue material that forms therein during molding is thus likewise reduced, the sprue being intended to be detached from the component being molded.

The chamber opens at one end into the extension of the cold runner and at the other end into an annular ring attached to the slide.

The second part of the ejection member has an overall shape that exhibits a symmetry of revolution and comprises a collar intended to collaborate with the stop-forming annular ring, a first end for contact with the sprue and a second end intended to slide in a central orifice of the annular ring.

The chamber has a cutout and a compression spring, forming elastic return means, which is housed in the cutout and positioned between two bearing seats formed by the collar and by one end of the cutout. Thanks to the compression spring, the second part of the ejection member is returned to the position of rest. It will further be appreciated that mounting the second part of the ejection member and the spring in the slide is a simple matter.

Another subject of the invention is a method for molding a plastic component, characterized in that a plastic component is molded in a molding device as defined hereinabove, and in that the plastic component is released from the mold after molding by performing the following steps:

the mobile part is moved with respect to the fixed part between the position in which the molding device is closed and the position in which the device is open, the slide remaining secured to the mobile part,

the slide is moved in a translational movement between the position in which the slide is closed and the position in which the slide is open such that the plastic component is detached from the sprue by breaking material and the two parts of the ejection member are more or less aligned, and

the first part of the ejection member which collaborates with the second part of the ejection member is moved between the position of rest and the sprue-ejection position and the sprue is ejected from the slide.

Yet another subject of the invention is a shade for a motor vehicle headlamp, characterized in that it is obtained using a method as defined hereinabove and in that it comprises a plastic breakage mark that is located on a backdraft of the shade.

### BRIEF DESCRIPTION OF THE ACCOMPANYING DRAWINGS

The invention will be better understood from reading the following description which is given solely by way of example and made with reference to the attached drawings in which:

FIG. 1 is a view in cross section of a molding device according to the invention, in the closed position; and

FIG. 2 is a view in cross section of the mobile part of the molding device of FIG. 1, in the open position.

### DETAILED DESCRIPTION OF THE PREFERRED EMBODIMENTS

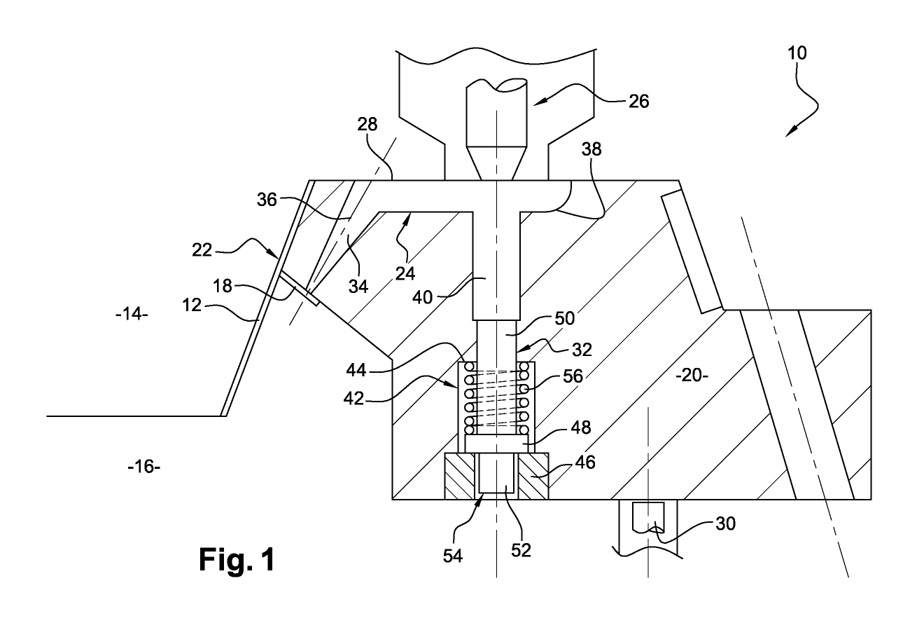

FIG. 1 depicts a device 10 for injection molding a plastic component 12, such as a motor vehicle headlamp shade.

The molding device 10 respectively comprises a fixed part 14 and a mobile part 16 which can be moved relative to one another between a position in which the molding device 10 is open and a position in which the device is closed.

It may be seen from FIG. 1 that the plastic component 12 comprises a rib 18 which has a backdraft surface. In order to be able to release the plastic component 12 after injection molding, the molding device 10 also comprises a slide 20 movable in a translational movement between a position in which the slide is open and a position in which the slide is closed.

In FIG. 1, the slide 20 and the fixed part 14 and mobile part 16 are in the closed position and form the cavity 22 in which the plastic component 12 is molded.

The slide 20 comprises a cold runner 24 which opens into that region of the molding cavity 22 that is intended to form the rib 18 of the component and allows the plastic to be injected into the molding cavity 22 without leaving signs of injection in a part of the plastic component 12 that has an optical or aesthetic function.

As the plastic is injected into the molding cavity 22 using an injection nozzle 26, the cold runner 24 fills with plastic which, as it cools, solidifies into sprue 28 which is then separated from the plastic component 12 and ejected from the cold runner 24 so that another plastic component 12 can be molded.

The sprue 28 is ejected from the cold runner 24 using an ejection member comprising at least two parts, the first part 30 which is borne by the mobile part 16 and the second part 32 which is borne by the slide 20.

In FIG. 1, the slide 20 is in the slide-closed position which corresponds to the position of rest of the first part 30 and of the second part 32 of the ejection member.

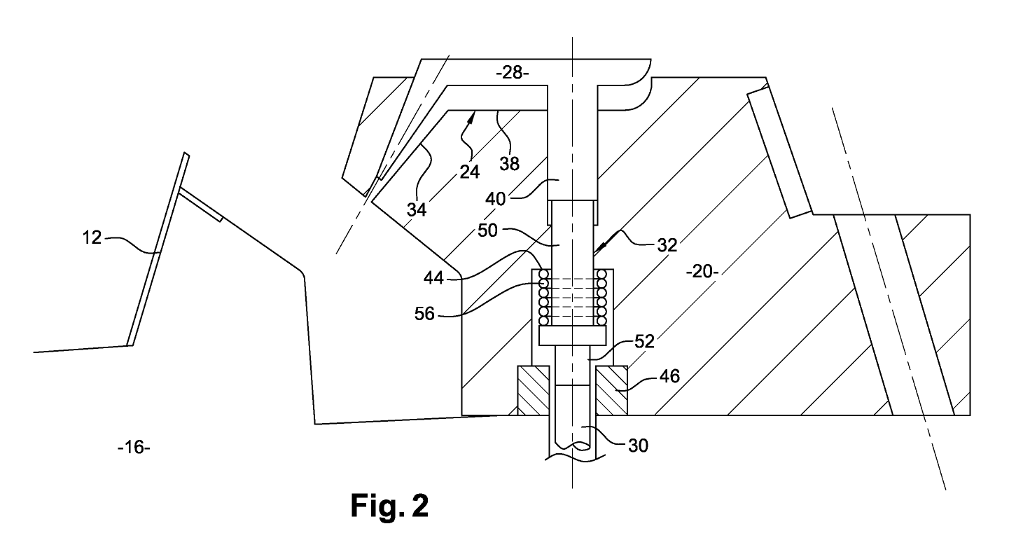

FIG. 2 depicts the fixed part 14 and mobile part 16 of the device 10 in the open position, which means to say that the fixed part 14 and the mobile part 16 of the device 10 are separated from one another so that a plastic component 12 can be released from the device 10.

FIG. 2 depicts the slide 20 also in the open position, which means to say that the two parts 30, 32 of the ejection member are more or less aligned and can collaborate with one another.

The ejection member 30, 32 therefore moves between a position of rest, depicted in FIG. 1, and a position for ejecting the sprue 28, which position is depicted in FIG. 2.

As can be seen from the figures, the slide 20 moves in a direction substantially perpendicular to the direction in which the ejection member 30, 32 moves.

Reference is made to FIG. 1 which depicts the cold runner 24 which comprises a plastic injection part 34 of substantially conical shape opening into the molding cavity 22. This conical shape converges toward the molding cavity 22 and more or less exhibits symmetry of revolution about an axis 36 that makes an angle of less than 45° with the direction of opening of the device 10. For preference, this angle is less than or equal to 30°.

The cold runner 24 also comprises a homogenizing cavity 38 connected firstly to a plastic-injection orifice of the injection nozzle 26 and secondly to the substantially conically shaped injection part 34.

The cold runner 24 further comprises an extension 40, of substantially cylindrical shape or, in this example, slightly conical shape, which extends between the homogenizing cavity 38 and one end of the second part 32 of the ejection member.

The first part 30 of the ejection member, which is of a shape that more or less exhibits symmetry of revolution, is slidably mounted in the mobile part 16 of the device 10. It is moved between the position of rest and the position for ejecting the sprue 28 by known means.

The second part 32 of the ejection member is slidably mounted in a chamber 42 formed in the slide 20. The chamber 42 opens at one end into the cold runner 24 and at the other end into an annular ring 46 attached to the slide 20 by known means.

The second part 32 of the ejection member has an overall shape exhibiting symmetry of revolution and comprises a collar 48 which, in this second part 32 of the ejection member, separates a first end 50 for contact with the sprue 28 from a second end 52 intended to slide in a central orifice 54 of the annular ring 46.

This second part 32 is movable between the rest position, toward which it is elastically returned by a compression spring 56, and the position for ejecting the sprue 28.

In this example, the chamber 42 comprises a cutout delimited by a shoulder 44 of the chamber 42. The chamber 42 is of a shape that more or less exhibits symmetry of revolution and comprises two coaxial parts of different cross sections.

The first end 50 slides in the part of the chamber 42 that has the smaller cross section. It will be appreciated that, in the position of rest, the first end 50 of the second part 32 of the ejection member delimits part of the cold runner 24. As plastic is injected into the device 10, the first end 50 closes the extension 40 of the cold runner 24 in its lower part.

The compression spring 56 is housed in the cutout of the chamber 42. It is positioned between two bearing seats which are formed by the collar 48 and by the shoulder 44 forming one end of the cutout.

The annular ring 46 forms an end stop when the second part 32 of the ejection member is in the position of rest.

The key stages in a method according to the invention for molding the plastic component 12 using the molding device 10 will be described hereinbelow.

First of all, with the molding device 10 in the closed position, the plastic component 12 is molded in the molding cavity 22 of the molding device 10. In this position, the two parts 30, 32 of the ejection member are offset.

Plastic is injected into the molding cavity 22 from the nozzle 26 and via the cold runner 24 that opens into that region of the molding cavity 22 that is intended to form the rib 18 of the plastic component 12.

After molding, the plastic component 10 is released from the mold by performing the following steps:

first of all, the mobile part 16 is moved with respect to the fixed part 14 of the molding device 10 between the closed and the open position. During this step of opening the molding device 10, the molded component 12 and the slide 20 remain secured to the mobile part 16;

then the slide 20 is moved in a translational movement between its closed position and its open position so that the plastic component 12 is detached from the sprue 28 by breakage of material and the two parts of the ejection member 30, 32 are substantially aligned;

next, the first part 30 of the ejection member which collaborates with the second part 32 of the ejection member is moved between the position of rest and the sprue-ejection position, and the sprue is ejected from the slide.

As soon as the slide 20 reaches the open position, the plastic component 12 can be released from the device 10.

Once the sprue 28 has been ejected from the slide 20 and the plastic component 12 has been released from the mold, the first part 30 of the ejection member is returned to the rest position. Under the effect of the compression spring 56, the second part 32 of the ejection member is returned to the position of rest, the collar 48 coming into abutment against the annular ring 46.

The slide 20 is moved into the closed position, in which the two parts 30, 32 of the ejection member are offset and the fixed part 14 and mobile part 16 are moved relative to one another from the position in which the device is open to the position in which the device is closed.

The device 10 is ready to be used.

It will be noted that a breakage mark caused by the breakage of plastic that occurs when the sprue 28 is detached from the plastic component 12 remains on the plastic component 12. This mark is located on a backdraft surface of the plastic component 12 which has no aesthetic function.

The device 10 can of course comprise several cold runners 24 comprised in one or more slides 20.

For example, it is possible to conceive of molding a motor vehicle headlamp shade comprising several tabs or ribs 18 with backdraft by injecting the plastic into several regions of the molding cavity 22 using cold runners 24 comprised in slides 20.

While the system and apparatus herein described constitute preferred embodiments of this invention, it is to be understood that the invention is not limited to this precise system or apparatus, and that changes may be made therein without departing from the scope of the invention which is defined in the appended claims.

What is claimed is:

1. A device for molding a plastic component, this device comprising two parts, respectively a fixed part and a mobile part, which can be moved relative to one another between a position in which the molding device is open and a position in which said device is closed, a slide movable in a translational movement between a position in which the slide is open and a position in which the slide is closed, the two parts of the device and the slide forming a cavity in which to mold the plastic component, wherein the slide comprises a cold runner opening into the molding cavity, in that the device comprises an ejection member, for ejecting plastic sprue formed in the cold runner, this ejection member being movable in an ejection direction and comprising at least a first part and a second part, the first part of the ejection member being borne by the mobile part of the device and the second part of the ejection member being borne by the slide, the slide being movable, substantially perpendicularly to the direction in which the ejection member moves, between a position in which the two parts of the ejection member are offset from one another, which corresponds to the closed position of the slide, and a position in which the two parts of the ejection member are more or less aligned with one another so that they can collaborate with one another, which corresponds to the open position of the slide, and in that the molding cavity comprises a zone intended to form a rib or a tab of the plastic component, the cold runner opening into this region.

2. The device according to claim 1, in which the cold runner comprises a plastic-injection part of substantially conical shape opening into the molding cavity and substantially converging toward this molding cavity.

3. The device according to claim 2, in which the cold runner comprises a homogenizing cavity connected on the one hand to a plastic-injection orifice of an injection nozzle and on the other hand to the injection part of substantially conical shape.

4. The device according to the claim 3, in which the cold runner comprises an extension extending between the homogenizing cavity and one end of the second part of the ejection member.

5. The device according to claim 1, in which the second part of the ejection member is slidably mounted in a chamber formed in the slide, the second part of the ejection member being movable between a position of rest toward which it is elastically returned, and a sprue-ejection position.

6. The device according to claim 5, in which the chamber opens at one end into the extension of the cold runner and at the other end into an annular ring attached to the slide.

7. The device according to the claim 6, in which the second part of the ejection member has an overall shape that exhibits a symmetry of revolution and comprises a collar intended to collaborate with the stop-forming annular ring, a first end for contact with the sprue and a second end intended to slide in a central orifice of the annular ring.

8. The device according to the claim 7, in which the chamber has a cutout and a compression spring, forming elastic return means, which is housed in the cutout and positioned between two bearing seats formed by the collar and by one end of the cutout.

9. A method for molding a plastic component, wherein said plastic component is molded in a molding device according to claim 1, and in that the plastic component is released from the mold after molding by performing the following steps:
the mobile part is moved with respect to the fixed part between the position in which the molding device is closed and the position in which said device is open, the slide remaining secured to the mobile part,
the slide is moved in a translational movement between the position in which the slide is closed and the position in which the slide is open such that the plastic component is detached from the sprue by breaking material and the two parts of the ejection member are more or less aligned, and
the first part of the ejection member which collaborates with the second part of the ejection member is moved between the position of rest and the sprue-ejection position and the sprue is ejected from the slide.

10. A shade for a motor vehicle headlamp, wherein it is obtained using a method according to claim 9 and in that it comprises a plastic breakage mark that is located on a backdraft of the shade.

11. The device according to claim 1 wherein said plastic component comprises a shade having a plastic breakage mark that is located on a backdraft of the shade.

12. The device according to claim 2, in which the second part of the ejection member is slidably mounted in a chamber formed in the slide, the second part of the ejection member being movable between a position of rest toward which it is elastically returned, and a sprue-ejection position.

13. The device according to claim 3, in which the second part of the ejection member is slidably mounted in a chamber formed in the slide, the second part of the ejection member being movable between a position of rest toward which it is elastically returned, and a sprue-ejection position.

14. The device according to claim 4, in which the second part of the ejection member is slidably mounted in a chamber formed in the slide, the second part of the ejection member being movable between a position of rest toward which it is elastically returned, and a sprue-ejection position.
